(19) United States
(12) Patent Application Publication
(10) Pub. No.: US 2005/0242588 A1
(43) Pub. Date: Nov. 3, 2005

(54) Integrated fuel cell and additive gas supply system for a power generation system including a combustion engine

(76) Inventor: Krik B. Washington, Vancouver (CA)

Correspondence Address: MCANDREWS HELD & MALLOY, LTD, 500 WEST MADISON STREET, SUITE 3400, CHICAGO, IL, 60661, US

(21) Appl. No.: 11/117,283

(22) Filed: Apr. 28, 2005

Related U.S. Application Data
(60) Provisional application No. 60/566,817, filed on Apr. 30, 2004.

(51) Int. Cl. H01M 8/00

(52) U.S. Cl. 290/1 A; 429/12

(57) ABSTRACT

An integrated fuel cell and additive gas supply system is designed for a power generation system that includes a combustion engine. The system includes: (a) a raw fuel storage and delivery subsystem, (b) a fuel processing and conditioning subsystem, (c) an oxidant processing and conditioning subsystem, (d) an actuatable fuel cell electric power generation subsystem, (e) an actuatable engine subsystem, and (f) a power conditioning and buffering subsystem. A hydrogen-containing fluid stream is introduced into the combustible oxidant stream to form a combined stream, and the combined stream and the combustible fuel stream are then separately introduced into the engine and combusted.

### CROSS-REFERENCE TO RELATED APPLICATION(S)

This application is related to and claims priority benefits from U.S. Provisional Patent Application No. 60/566,817 filed Apr. 30, 2004, which is hereby incorporated by reference herein in its entirety.

### FIELD OF THE INVENTION

The present invention relates to power generation systems. In particular, the present invention relates to an integrated fuel cell and additive gas supply system for a power generation system that includes a combustion engine. Although suitable for use in stationary power generation applications, the present system is particularly suited to vehicular applications in which a combustion engine is the primary motive power source.

### BACKGROUND OF THE INVENTION

Designers of combustion engine systems have been under constant pressure to reduce operating costs, increase fuel efficiency and also to reduce emissions. Oftentimes in the past, engine design and operating changes made to reduce emissions have resulted in reduced fuel efficiency. Engine developers have expended sizable capital over the past decades to develop engine designs and operating methods to reduce emissions and improve fuel efficiency. Nevertheless, government regulations and business demands continue to urge engine developers to reduce emissions and increase fuel efficiency.

Long-haul transport vehicles must run their large diesel engines at idle when parked so that power can continue to be supplied to the vehicle's electrical systems, including cab-mounted comfort and safety equipment, as well as equipment associated with the freight being transported, such as refrigeration equipment. Government regulations and business demands are urging further decreases in permissible engine idle time, both to reduce noise and exhaust emissions and to reduce driver service hours. These regulations and demands have resulted in reduced profitability in an industry with inherently low profit margins.

Any system that could assist in meeting government regulations by reducing emissions while at the same time improving fuel efficiency would have considerable business value. This would especially be true if the system were able to significantly reduce engine idling time, thereby reduce engine wear and increasing engine life time and service intervals.

A system as described herein would improve fuel efficiency and/or increase power available from the engine by using fuel processing capabilities to assist the combustion engine. The auxiliary power system would improve fuel efficiency by producing power more efficiently than a conventional engine that produces electrical power using an alternator driven by the combustion engine. The auxiliary power system would also reduce wear and tear on the engine because, instead of idling the vehicle when auxiliary power is needed, the auxiliary system could power on-board electrical features not currently available in conventional vehicles because of the load demands those features would impose.

Presently, diesel-fuelled auxiliary power units (APUs) are available for use with long-haul vehicles. These units allow a truck driver to turn off the vehicle's primary diesel engine and still have power generated by the APU. APUs can thus reduce fuel consumption during times the vehicle is stopped, but noise and exhaust pollution remain problematic because APUs still employ diesel engines. APUs also become superfluous electric power generators while the truck is driving.

Some long-haul vehicle developers are presently working to develop APUs that employ solid oxide fuel cells (SOFC) to generate electric power to drive the vehicle's auxiliary equipment. These SOFC-based systems convert gasoline and diesel fuel to a hydrogen-containing fluid stream that is then supplied to the SOFC. Research and development groups have been working to develop gasoline and diesel fuel reformers for decades. It is agreed that there is much work remaining before there will be a practical, commercially viable reforming device. SOFCs are also inherently problematic because of their inability to be thermal-cycled in the frequencies required for use in passenger vehicles or a long-haul transport trucks. SOFCs also require an unacceptably lengthy amount of time to be heated to operating temperature.

On many prior occasions, hydrogen has been considered as a potentially suitable fuel source for IC engines, primarily because of the potential of hydrogen to reduce the number and amounts of toxic emissions in comparison to IC engines fuelled by gasoline, diesel and other hydrocarbon-based fuels. Tests performed on IC engines that employ hydrogen as either the primary fuel or as an additive to the fuel stream have shown at least partially reduced toxic emissions. A number of Society of Automotive Engineers (SAE) papers from the 1970s and 1980s report increases in fuel efficiency and reduction of exhaust emissions when hydrogen is added to the combustion mixture of an IC engine. Since hydrogen has a significantly wider flammability range than gasoline or diesel fuel, a small amount of added hydrogen can make the combustion mixture fuel lean without producing unstable combustion. The fuel lean mixture results in lower engine operating temperatures, thereby increasing engine efficiency and reducing the amount of nitrogen oxide emissions.

Although the benefits of added hydrogen have long been known, such hydrogen addition has been impractical to implement. Storage of gaseous or liquid hydrogen on-board a vehicle has remained impractical because the equipment available to convert a hydrocarbon stream to hydrogen-containing fluid stream was designed as large industrial units that operated at steady state in petrochemical plants. These designs were not suitable for use in long-haul transport vehicles. More recently, development work has been performed to create small load-following conversion devices at prices low enough to be considered for the automotive industry.

Electrolyzers have been used to produce hydrogen on-board a vehicle. Although such electrolyzers can supply hydrogen to the engine while driving, they do not have the capability to supply electrical power when the vehicle is not moving.

Prior fuel cell designs, such as, for example, solid oxide electrolyte fuel cells and phosphoric acid electrolyte fuel cells, have been shown to be unsuitable for use in transportation vehicles, principally because of their inability to meet numerous practical requirements. Such requirements include the ability of the vehicle to be started immediately, the imposition of frequent on/off cycles on the vehicular propulsion system, the ability of the vehicle's power-producing device to withstand normal vibrations and stresses from imperfect road conditions, as well as health and safety requirements.

Absent from prior designs to date are affordable and efficient vehicular power generation systems in which a hydrogen-containing stream is the fuel source for: (1) a fuel cell stack that powers on-board and/or off-board electrical devices and systems, and (2) an additive stream that can be fed to the engines air intake stream and/or the after-treatment system.

The present integrated fuel cell and additive gas supply system provides four principle advantages in comparison to the foregoing prior designs: (1) a reduction in vehicular operating costs due to a reduction in vehicular fuel consumption while driving, (2) a reduction in vehicular engine emissions during driving and during cold start up, (3) a reduction in engine idle time resulting in reduced fuel consumption and engine wear and (4) a reduction in vehicular capital costs required to provide all these benefits and meet regulated emission levels.

As to the reduction in vehicular operating costs, the present integrated system improves the fuel efficiency of the IC engine during driving. Also, when the vehicle is stopped, the IC engine need not operate in an inefficient operating mode. Instead, the present integrated system supplies electrical power at greater efficiencies than the IC engine in similar operating modes. The vehicle's operational maintenance costs are also reduced due to reduced engine run time and cleaner combustion, which results in engine oil service intervals being extended. The present integrated system also enables vehicle subsystems to be powered electrically by the fuel cell system during times when the IC engine is operating and an alternator is being used. Since the fuel cell system will be more efficient in powering such subsystems than the IC engine/alternator combination, fuel consumption can also be decreased.

As to the reduction of vehicle emissions, the present integrated system permits a lean-burn air/fuel mixture to be introduced to the IC engine by the addition of a hydrogen-containing gas stream to the air intake of the IC engine. The lean combustion mixture results in lower combustion temperatures and thus lower emissions and greater efficiency. The efficiency of the catalytic converter in the present system is also improved because the hydrogen will allow the catalytic converter to reach operating temperature much faster than in conventional systems. Hydrogen-containing gas (such as, for example, a mixture of hydrogen and carbon monoxide, commonly referred to as “syngas”) can be used to improve after treatment systems in a number of different ways. Finally, exhaust and noise emissions are reduced or minimize in the present system because the vehicle's electrical subsystems can be powered from a source other than the IC engine, thereby allowing the engine to be turned off when the vehicle is parked.

The reduced engine run time that results from the fuel cell providing power during times at which the truck is stopped, thereby resulting in less engine wear and extended maintenance intervals in comparison to conventional systems. The fuel cell auxiliary power source will also enable additional electrical features not currently available on conventional vehicles. These additional features include, for example, telecommunications, guidance, navigational, lighting, security and/or surveillance systems, and driver comfort features such as, for example, computer, music and video systems. For military applications, the auxiliary source could also power weapon systems. These benefits thus improve the economic performance of operating the vehicle.

The present integrated system also reduces the capital cost of the vehicle by assisting with emission reduction. Emission reduction equipment typically reduces fuel efficiency. The present system should improve fuel efficiency sufficiently to offset its costs to develop and install. The present system also reduces emissions, thereby enabling the removal or downsizing of other emission reduction equipment and reducing costs accordingly.

In summary, then, the present integrated system can provide the following functional and operational advantages:
(1) Employing hydrogen as an engine air intake additive increases fuel efficiency and reduces emissions.
(2) The diesel engine does not need to operate at a very inefficient point while the vehicle is stopped. This increases engine lifetime, reduces emissions and reduces fuel consumption.
(3) Integration of a proton exchange membrane fuel cell system with diesel engine system permits immediate start-ups.
(4) Use of an energy buffered power delivery system allows a smaller fuel processing and fuel cell system to be used and thus reduces costs as well as providing other benefits.

### SUMMARY OF THE INVENTION

In one embodiment of the present integrated fuel cell and additive gas supply system for a power generation system including a combustion engine, the system comprises:
(a) a raw fuel storage and delivery subsystem comprising at least one raw fuel source capable of evolving a hydrogen-containing fluid stream, at least one storage vessel for containing the at least one raw fuel, and a conduit assembly for emitting at least one raw fuel stream;
(b) a fuel processing and conditioning subsystem for producing a hydrogen-containing fluid stream from at least one raw fuel stream;
(c) an oxidant processing and conditioning subsystem for producing an oxygen-containing fluid oxidant stream from a raw oxidant source that, optionally, could be integral to and/or drawn from the engine oxidant supply and conditioning system;
(d) an actuatable fuel cell electric power generation subsystem comprising an electrochemical fuel cell for generating electric current, heat, and product water from the processed and conditioned fuel stream and the processed and conditioned oxidant stream;
(e) an actuatable engine subsystem comprising a combustion engine for generating mechanical power, heat and an engine exhaust stream from a combustible fuel stream and a combustible oxidant stream; and
(f) a power conditioning and buffering subsystem for providing conditioned electric power upon demand to at least one electrical load.
   A hydrogen-containing fluid stream is introduced into the combustible oxidant stream to form a combined stream, and the combined stream and the combustible fuel stream are then separately introduced into the engine and combusted.

The raw fuel is preferably selected from the group consisting of hydrogen, organic compounds capable of evolving hydrogen and inorganic compounds capable of evolving hydrogen. The raw fuel can be a fluid hydrogen source (that is, a gaseous hydrogen source and/or a liquid hydrogen source). The organic compounds are preferably selected from the group consisting of hydrocarbons, organic alcohols, organic acids and their salts, and esters. The inorganic compounds include nitrogen compounds such as ammonia (NH₃).

The fuel processing and conditioning subsystem can produce a plurality of hydrogen-containing fluid streams. The fuel cell electric power generation subsystem can comprise a plurality of electrochemical fuel cells. The electrochemical fuel cell may further generate a fuel exhaust stream and an oxidant exhaust stream. The combustion engine can be either of a combustion engine and an external combustion engine.

In a preferred embodiment, the combustion engine generates mechanical power to energize a vehicle. The combustion engine can also generate mechanical power to energize a stationary power system.

The fuel cell may produce a fuel exhaust stream and the hydrogen-containing fluid stream can be drawn from at least one of the fuel processing and conditioning system and the fuel cell fuel exhaust stream. The engine can include at least one combustion chamber, the combined stream and the combustible fuel stream being separately introduced into the at least one combustion chamber and then combusted.

The at least one raw fuel source can comprise a raw primary fuel source capable of undergoing combustion and a raw secondary fuel source capable of evolving a hydrogen-containing fuel stream. The at least one storage vessel can comprise a primary storage vessel for containing the raw primary fuel and a secondary storage vessel for containing the raw secondary fuel. The conduit assembly can emit a raw primary fuel stream and a raw secondary fuel stream. The fuel processing and conditioning subsystem then produces a hydrogen-containing fluid fuel stream from the raw secondary fuel stream.

In one embodiment, the at least one raw primary fuel source has the same composition as the raw secondary fuel source. In another embodiment, the at least raw primary fuel source is selected from the group consisting of a gasoline fuel source and a diesel fuel source, and the raw secondary fuel source is at least one of a propane fuel source, a butane fuel source, a liquid petroleum gas (LPG) fuel source, and mixtures of at least one of the propane fuel source, the butane fuel source and the LPG fuel source.

In a preferred embodiment, the fuel processing and conditioning subsystem further comprises a filter and compressor for producing a filtered and compressed hydrogen-containing fluid fuel stream. The fuel processing and conditioning subsystem can further comprise a fuel humidification subsystem for imparting water to the hydrogen-containing fluid fuel stream to produce a humidified hydrogen-containing fluid fuel stream.

The fuel processing and conditioning subsystem can further comprise a fuel adsorbent system to control the hydrogen-containing fluid fuel stream concentration. In one embodiment, the fuel adsorbent system comprises at least one of a pressure swing adsorption system and a partial pressure adsorbent system.

The fuel processing and conditioning system can further comprise a semi-permeable membrane for imparting at least one of compositional and mechanical control to the hydrogen-containing fluid fuel stream. The membrane preferably controls the concentration of hydrogen in the hydrogen-containing fluid fuel stream. The membrane can comprise at least one of a polymer membrane and a sintered metal membrane.

The fuel processing and conditioning subsystem can comprise a reformer for producing a hydrogen-containing fluid fuel stream from one of the at least one raw fuel stream. The reformer can comprise at least one of an autothermal reformer, a steam reformer and a partial oxidation reformer.

The oxidant processing and conditioning subsystem can further comprise an oxidant adsorbent system to control the oxygen-containing fluid oxidant stream concentration. The oxidant adsorbent system can comprise at least one of a pressure swing adsorption system and a partial pressure adsorbent system.

The oxidant processing and conditioning system can further comprise a semi-permeable membrane for imparting at least one of compositional and mechanical control to the oxygen-containing fluid oxidant stream. The membrane preferably controls the concentration of oxygen in the oxygen-containing fluid oxidant stream. The membrane can comprise at least one of a polymer membrane and a sintered metal membrane.

The oxidant processing and conditioning system can increase a supercharger, turbocharger or may operate under vacuum.

In one embodiment, the fuel cell electric power generation subsystem is actuatable to generate electric current when the engine subsystem is not actuated. In another embodiment, the engine subsystem is actuatable to generate mechanical power when the fuel cell electric power generation subsystem is not actuated. In yet another embodiment, the fuel cell electric power generation subsystem is actuatable to generate electric current when the engine subsystem is actuated to generate mechanical power. In still another embodiment, the engine subsystem is actuatable to generate mechanical power when the fuel cell electric power generation subsystem is actuated to generate electrical current.

The power conditioning and buffering subsystem can comprise one or more of a DC-to-AC power inverter, a voltage step-up/step-down device, a current step-up/step-down device and a frequency modulation device. The power conditioning and buffering subsystem can comprise a device for storing and releasing electric current upon demand, such as one or more capacitors and/or one or more batteries. Most preferably, the power conditioning and buffering subsystem comprises a DC-to-AC power inverter, one or more capacitors and one or more batteries.

In one embodiment, at least a portion of the hydrogen-containing fluid fuel stream is directed to at least one emission control device. The portion of the hydrogen-containing fluid fuel stream is preferably at least periodically, and in some preferred embodiments continuously, directed to the at least one emission control device, most preferably at predetermined intervals. The emissions control device(s) can comprise a catalyst and an adsorbent, typically contained in a bed through which the engine exhaust stream is directed, and which adsorbs one or more emission constituents, such as nitrogen oxides (NOx), sulfur oxides (SOx), or renders benign one or more emission constituents such as by converting carbon monoxide to carbon dioxide and by, for example, converting uncombusted hydrocarbons to water and carbon dioxide.

The fuel cell preferably comprises a proton exchange membrane (PEM). The fuel cell preferably comprises a device to reject heat generated by the fuel cell.

### BRIEF DESCRIPTION OF THE DRAWING(S)

FIG. 1 is a schematic flow diagram illustrating a preferred embodiment of the present integrated electric power and gas additive supply system for a combustion engine-propelled vehicle.

### DETAILED DESCRIPTION OF PREFERRED EMBODIMENT(S)

The present integrated electric power and gas additive supply system comprises the following principal subsystems:
(a) a hydrocarbon storage and delivery subsystem;
(b) a fuel processing and conditioning subsystem;
(c) an oxidant processing and conditioning subsystem;
(d) a fuel cell electric power generation subsystem;
(e) an engine subsystem; and
(f) a power conditioning and buffering system.
   Hydrocarbon Storage and Delivery Subsystem

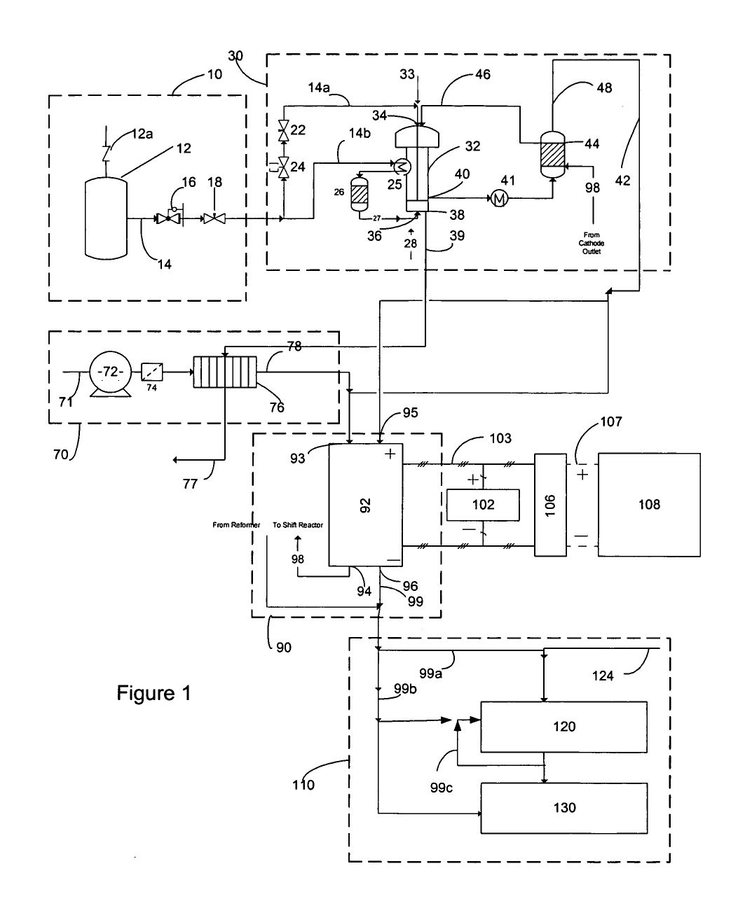

Referring to FIG. 1, a hydrocarbon storage and delivery subsystem 10 includes a storage tank 12 and a series of control valves 16, 18 for directing a fluid fuel stream 14 to a downstream fuel processing subsystem, as described below. The fluid fuel employed in the embodiment of FIG. 1 is propane, but could also be any other suitable fluid fuel or mixture of fuels from which hydrogen can be generated. Examples are gasoline, diesel, methanol, natural gas and various mixes of liquid petroleum gas. It is even possible to use compressed or liquid hydrogen. In some embodiments an electrolyzer may be used instead of or in addition to using a tank filled with material from which hydrogen can be generated. Tank 12 may or may not be pressurized above atmospheric pressure, depending upon the nature of the material involved and the configuration of the downstream system components. It is contemplated that tank 12 would be filled in a manner similar to conventional pumping of gasoline into a conventional vehicle fuel tank. Raw fuel would thus be introduced into tank 12 at filling point 12a shown in FIG. 1. Ammonia and/or similar nitrogen-based compounds capable of evolving hydrogen could also be employed as the source of hydrogen. In this event many of the processing and conditioning components will be different from those for evolving hydrogen from hydrocarbons and other carbon-based compounds.

A fluid fuel (preferably propane) stream 14 is withdrawn from storage tank 12 by the actuation of one or more suitably configured valve(s), which are illustrated in FIG. 1 as pressure control valve 16 and flow control valve 18. The valve(s) and/or piping configuration of subsystem 10 are designed to draw fuel stream 14 from storage tank 12 at a predetermined pressure. The flow rate of fuel stream 14 may or may not be controlled with a control device or assembly of devices, depending upon the nature of the hydrocarbon involved and the configurational requirements of the downstream system components. When controlled, the pressure and/or flow rate of fuel stream 14 could be set to remain constant, or alternatively, varied according to one or more system operating parameters.

Fuel Processing Subsystem

Fuel stream 14 is directed to a fuel processing subsystem 30, where a hydrogen-containing reformate stream 42 is eventually formed by the catalytic conversion of fuel stream 14. Some or all of this conversion could take place in the absence of a catalyst, such as where the converter operates at sufficiently high temperature to effect the conversion on its own. In the embodiment illustrated in FIG. 1, fuel stream 14 branches into a first fluid stream 14a and a second fluid stream 14b. First stream 14a is eventually directed to reformer burner inlet 34 of reformer 32, flowing first through a shut-off valve 22 and a flow control valve 24. Before entering reformer burner inlet 34, stream 14a is mixed with an oxygen-containing stream 46, such as air, and is also optionally mixed with a second fuel stream 33, if available, drawn from the fuel cell stack anode exhaust stream, as described below. Oxygen-containing stream 46 can be drawn from the fuel cell stack cathode exhaust stream, as described below.

Other available streams drawn from other portions of the system of FIG. 1 may be also suitable for directing to the reformer burner inlet 34, depending upon the particular configuration of the system. Streams 14a, 33 and 46 may or may not be heated by a waste heat stream via a heat exchanger to increase system efficiency.

The merged stream formed by the mixture of stream 14a, oxygen-containing stream 46, and optionally additional fuel stream 33 is then combusted and used to provide energy to reformer 32 used to catalytically reform the fuel within stream 14a into a hydrogen-containing reformats stream 42, which exits reformer 32 at outlet 40. The reformer burner exhaust stream 39 exits reformer 32 at outlet 38, as shown in FIG. 1, after which exhaust stream 39 is directed to a downstream oxidant processing subsystem for use, as described below, in preheating the oxidant stream directed to the fuel cell stack.

A second fluid stream 14b is first directed through a heat exchanger 25 associated with reformer 32, as shown in FIG. 1. Depending upon the nature of the hydrocarbon fuel stored in the tank 12, it may be necessary or desirable to remove certain constituents of second fluid stream 14b. For example, and as shown in FIG. 1, heated stream 14b is directed to the inlet of a sulfur adsorbent bed reactor 26, which removes sulfur from stream 14b to produce a decontaminated fuel stream 27 before being directed to the catalytic reformer, thereby preventing poisoning of the reforming catalyst that might occur if the contaminants were not removed. Persons skilled in the technology involved here will recognize, of course, that a number of methods are available for removing contaminants besides, or in addition to, the adsorbent bed reactor illustrated in FIG. 1. Such methods include pressure swing adsorption, use of a membrane filter, use of an amine or like solution to remove sulfur components, and use of hydrogen and a hydro-desulfurization process.

The illustrated system employs a steam reformation process, in which the hydrocarbon fuel stream and water are combined and converted catalytically to a hydrogen-containing reformate stream. As shown in FIG. 1, decontaminated fuel stream 27 exiting reactor 26 is augmented by a water-containing stream 28, which preferably contains product water from the oxidant exhaust stream 98 exiting fuel cell stack 92, described in more detail below. Augmented fuel stream 27 is then introduced to reformer 32 at inlet 36.

It is also possible to introduce the fuel stream from the storage tank to a reforming reactor without being split into two different streams, as in the case of streams 14a and 14b in FIG. 1. In this case, an oxygen-containing stream could be mixed with the fuel stream, as in the process commonly referred to as autothermal reforming. It is also possible to further introduce a water-containing stream, in addition to the oxygen-containing stream, into the mixed fuel stream such that partial oxidation and steam reforming could all take place in the same reactor. With the proper reactor design, heat exchange and catalyst selection, water-gas shift reactions could also be performed in the same reactor. In the event that ammonia is employed as the source from which hydrogen is to be evolved, such reactors would be different from those for evolving hydrogen from hydrocarbons and other carbon-based compounds.

Persons skilled in the technology involved here will appreciate, of course, that one or more of the streams fed to the reformer can be preheated using a source of waste heat from some portion of the system to increase the overall efficiency of the system.

As further shown in FIG. 1, the hydrogen-containing reformate stream 42 exiting reformer 32 is directed through a heat exchanger 41 and then fed to one or more additional reactor(s), one of which is shown in FIG. 1 as shift reactor 44, to increase the concentration of hydrogen in the reformate stream and to remove other constituents. Examples of such additional reactors include water-gas shift reactors, selective oxidation reactors, and pressure swing adsorption units. Processed reformate stream 48 is then directed to any downstream conditioning processes that may be necessary or desirable. Such downstream conditioning processes could include cooling, humidification and removal of liquid water from the stream. These processes would be completed prior to introducing the hydrogen-containing stream to the downstream fuel cell stack to provide more efficient fuel cell operation.. As shown in FIG. 1, optional oxidant exhaust stream 98 from the downstream fuel cell stack can also be fed to shift reactor 44 as a heat exchange fluid to adjust the temperature of the reactor, thereby providing more effective conditions for the water-gas shift reaction.

Oxidant Processing and Conditioning Subsystem

FIG. 1 further shows an oxidant processing subsystem 70, in which a stream 71 from an oxidant source, preferably air, is directed through a blower 72 and filter 74, which removes contaminants that could poison the fuel cell electrocatalyst, damage downstream equipment, or otherwise diminish system performance. The pressurized and filtered oxidant stream 71 is then passed through a preheater 76 to produce a heated oxidant stream 78. Preheater 76 draws heat from reformer exhaust stream 39, which passes through preheater 76 and exits as stream 77.

The oxidant stream could also be supplied to the system by one or more methods, such as, for example, passing an ambient air stream through a filter and then compressing the air stream to a desired pressure using one of many different types of equipment and designs. The air stream could also be conditioned by adjusting the temperature and/or water content of the stream, such as by employing a waste heat source (the reformer burner exhaust stream, for example) to increase the temperature of the air to that of the operating temperature of the downstream fuel cell stack. Another potential conditioning step would involve humidifying the air stream. In general, it is desirable to minimize the number and complexity of components the oxidant processing subsystem 70 to reduce the overall cost, mass and volume of the system. Therefore, a design in which the oxidant stream did not require conditioning is preferred. If the oxidant is to be compressed or enriched, a trade-off is made among primary requirements of the system. In many cases, the primary requirements will be related to efficiency and cost.

Fuel Cell Electric Power Generation Subsystem

As shown in FIG. 1, a fuel cell electric power generation subsystem 90 includes a fuel cell stack 92 to which heated oxidant stream 78 is introduced at oxidant stream inlet 93. Reformate stream 42 is introduced to fuel cell stack 92 at fuel stream inlet 95. Fuel cell stack 92 generates electric current, heat and product water from a catalyzed electrochemical reaction of hydrogen contained in reformate stream 42 and oxygen contained in oxidant stream 78. Fuel exhaust stream 99, from which hydrogen would be depleted from the electrochemical reaction within fuel cell stack 92, exits stack 92 at fuel stream outlet 96 Oxidant exhaust stream 98 exits stack 92 at oxidant stream outlet 94, and can be, optionally, directed to shift reactor 44 as a heat exchange fluid. As previously described, product water from oxidant exhaust stream 98 exiting fuel cell stack 92 is used to augment decontaminated fuel stream 27 introduced to reformer 32. The fuel cell design can be modified in various ways to minimize or reduce the number and complexity of the other system components.

Although different types of fuel cells and fuel cell stacks could be employed in the present system, a PEM fuel cell stack exhibits the favorable attributes of tolerance to vibrations and immediate production of electric power upon start-up.

Power Conditioning and Buffering Subsystem

In a power conditioning and buffering subsystem 100 shown in FIG. 1, the electrical current generated by the fuel cell stack is directed to via an electric circuit 103 to a power conditioning device 106, where the current is conditioned to the desired voltage and frequency for powering vehicle electrical equipment 108, which periodically draws electric current upon demand from power conditioner 106 via leads 107.

As further shown in FIG. 1, the fuel cells within stack 92 are preferably operated in parallel with a battery 102. Since battery 102 is an energy storage device, the battery can supply power to vehicle electrical equipment 108 at power demand levels above those the fuel cell stack can provide. When the power demand is less than the fuel cell stack's maximum capacity, the batteries are recharged. In a typical operating profile, the batteries cycle around a midpoint of their charge level as the electrical load fluctuates. Other devices such as, for example, capacitors or one or more capacitor banks could also perform the energy buffering function.

The electrical equipment powered by fuel cell stack 92 and batteries 102 include those typically associated with on-the-road vehicles, especially of the type typically installed on a tractor or a truck, or a trailer being pulled by the tractor or truck. Examples of such electrical equipment include radios, computers, microwave ovens, lamps, heaters and other electrical devices for driver and passenger comfort and safety. Studies have been performed by various groups, including the University of California at Davis, that document power draws of typical electrical equipment present in long-haul transport vehicles. Such electrical equipment could also include freight-related devices such as lift gates and refrigeration system components. When properly configured, the system could also supply electric power to equipment independent of the truck or tractor.

Engine Subsystem

Engine subsystem 110 shown in FIG. 1 includes an internal combustion engine 120, a catalytic converter 130, and associated inlet and outlet streams. As further shown in FIG. 1, fuel exhaust stream 99 from fuel cell subsection 90 branches into first and second hydrogen-containing streams 99a and 99b. First branch stream 99a is combined with an air intake stream 124 and introduced to the intake manifold of IC engine 120. Second branch stream 99b can also be fed directly to engine 120, without first being combining with an air intake stream. Additionally, or alternatively, second branch stream 99b can be combined with the IC engine exhaust stream before directing the combined stream to catalytic converter or lean NOx trap 130. Still additionally, or alternatively, branch stream 99b can be fed directly to catalytic converter 130 or other device for improving fuel efficiency and/or reducing emissions from the IC engine. This device could be a converter that employs a catalyst-adsorbent bed, an example of which is sometimes referred to as a lean NOx trap. It is contemplated that, during start-up, a hydrogen-containing gas stream would be drawn from a suitable extraction point in the fuel processing subsystem 30 and directed to the engine and/or the catalytic converter. A hydrogen-containing gas stream could also be drawn from such a suitable extraction point during normal operation and used.

Fuel exhaust stream 99 from fuel cell subsection 90 could also be directed into air intake stream 124 to reduce engine emissions and improve fuel efficiency. Fuel exhaust stream 99 could also be injected into the exhaust gas recirculation (EGR) stream 99c.

In some system applications, a hydrogen-containing stream could be supplied from the fuel cells stack's fuel exhaust stream or from a suitable point in fuel processing subsystem 30. Additionally, or alternatively, a raw, unreformed hydrocarbon gas stream could be fed directly to the IC engine via the air intake stream.

The fuel cell stack's oxidant exhaust stream could also be added to the EGR stream because it has the desired properties of purity and coolness.

A further coolant circulation subsystem (not shown in FIG. 1) could also be included in the present system to provide cooling for the fuel cell, depending upon the operational requirements of the system. It is preferable, of course, to omit such a coolant subsystem, since it adds cost, weight and volume, and instead cool the fuel cell stack passively.

The present integrated fuel cell and additive gas supply system is structurally and functionally distinguished from conventional, prior art systems in at least the following respects:
(1) the present integrated system employs an easily reformed hydrocarbon as the source of hydrogen rather than diesel fuel employed in conventional systems.
(2) the present integrated system employs proton exchange membrane fuel cells rather than solid oxide electrolyte fuel cells that have significant practical concerns when used in vehicles.
(3) the present integrated system employs a fuel cell and battery combination rather than relying only upon a fuel cell as the source of electric power.
(4) the present integrated system also directs hydrogen to a fuel cell stack for generating electric power rather than only directing hydrogen as an additive stream to an IC engine.
(5) the present integrated system employs a hydrocarbon (preferably propane) as a source of reformed hydrogen for use in a fuel cell stack for generating electric power rather than only directing the hydrocarbon to the IC engine.
(6) the present integrated system can extract a hydrogen-containing gas stream from point(s) in the fuel processing system and employ it immediately in the IC engine and/or catalytic converter during cold start-up.

The following results are achievable with the present integrated system:
(a) Reduction of fuel consumption by approximately 5-30%.
(b) Increase of power output by approximately 5-15%.
(c) Reduction of particulate matter and NOx emissions by up to approximately 70%.
(d) Extending of IC engine life.

While particular elements, embodiments and applications of the present invention have been shown and described, it will be understood, of course, that the invention is not limited thereto since modifications may be made by those skilled in the art without departing from the scope of the present disclosure, particularly in light of the foregoing teachings.

1. An integrated fuel cell and additive gas supply system for a power generation system including a combustion engine, the system comprising:
(a) a raw fuel storage and delivery subsystem comprising at least one raw fuel source capable of evolving a hydrogen-containing fluid stream, at least one storage vessel for containing said at least one raw fuel, and a conduit assembly for emitting at least one raw fuel stream;
(b) a fuel processing and conditioning subsystem for producing a hydrogen-containing fluid stream from one of said at least one raw fuel stream;
(c) an oxidant processing and conditioning subsystem for producing an oxygen-containing fluid oxidant stream from a raw oxidant source;
(d) an actuatable fuel cell electric power generation subsystem comprising an electrochemical fuel cell for generating electric current, heat, and product water from said processed and conditioned fuel stream and said processed and conditioned oxidant stream;
(e) an actuatable engine subsystem comprising a combustion engine for generating mechanical power, heat and an engine exhaust stream from a combustible fuel stream and a combustible oxidant stream; and
(f) a power conditioning and buffering subsystem capable of receiving electric current from said electrochemical fuel cell, said power conditioning and buffering subsystem providing conditioned electric power upon demand to at least one electrical load;
wherein a hydrogen-containing fluid stream is introduced into said combustible oxidant stream to form a combined stream, and said combined stream and said combustible fuel stream are then separately introduced into said engine and combusted.

2. The integrated system of claim 1 wherein said raw fuel is selected from the group consisting of hydrogen, organic compounds capable of evolving hydrogen and inorganic compounds capable of evolving hydrogen.

3. The integrated system of claim 2 wherein said raw fuel source is a fluid hydrogen source.

4. The integrated system of claim 3 wherein said raw fuel source is a gaseous hydrogen source.

5. The integrated system of claim 3 wherein said raw fuel source is a liquid hydrogen source.

6. The integrated system of claim 2 wherein said organic compounds are selected from the group consisting of hydrocarbons, organic alcohols, organic acids and their salts, and esters.

7. The integrated system of claim 2 wherein said inorganic compounds are nitrogen compounds.

8. The integrated system of claim 7 wherein said nitrogen compound is ammonia (NH₃).

9. The integrated system of claim 1 wherein said fuel processing and conditioning subsystem produce a plurality of hydrogen-containing fluid streams.

10. The integrated system of claim 1 wherein said fuel cell electric power generation subsystem comprises a plurality of electrochemical fuel cells.

11. The integrated system of claim 1 wherein said electrochemical fuel cell further generates a fuel exhaust stream and an oxidant exhaust stream.

12. The integrated system of claim 1 wherein said combustion engine is an internal combustion engine.

13. The integrated system of claim 1 wherein said combustion engine is an external combustion engine.

14. The integrated system of claim 1 wherein said combustion engine generates mechanical power to energize a vehicle.

15. The integrated system of claim 1 wherein said combustion engine generates mechanical power to energize a stationary device.

16. The integrated system of claim 1 wherein said fuel cell produces a fuel exhaust stream, and said hydrogen-containing fluid stream is drawn from at least one of said fuel processing and conditioning system and said fuel cell fuel exhaust stream.

17. The integrated system of claim 1 wherein said engine comprises at least one combustion chamber and said combined stream and said combustible fuel stream are separately introduced into said at least one combustion chamber and combusted.

18. The integrated system of claim 1 wherein said at least one raw fuel source comprises a raw primary fuel source capable of undergoing combustion and a raw secondary fuel source capable of evolving a hydrogen-containing fuel stream, said at least one storage vessel comprises a primary storage vessel for containing said raw primary fuel and a secondary storage vessel for containing said raw secondary fuel, said conduit assembly emits a raw primary fuel stream and a raw secondary fuel stream, and said fuel processing and conditioning subsystem produces a hydrogen-containing fluid fuel stream from said raw secondary fuel stream.

19. The integrated system of claim 18 wherein said at least one raw primary fuel source has the same composition as the raw secondary fuel source.

20. The integrated system of claim 18 wherein said at least raw primary fuel source is selected from the group consisting of a gasoline fuel source and a diesel fuel source, and said raw secondary fuel source is at least one of a propane fuel source, a butane fuel source, a liquid petroleum gas (LPG) fuel source, and mixtures of at least one of said propane fuel source, said butane fuel source and said LPG fuel source.

21. The integrated system of claim 1 wherein said fuel processing and conditioning subsystem further comprises a filter and compressor for producing a filtered and compressed hydrogen-containing fluid fuel stream.

22. The integrated system of claim 1 wherein said fuel processing and conditioning subsystem further comprises a fuel humidification subsystem for imparting water to said hydrogen-containing fluid fuel stream to produce a humidified hydrogen-containing fluid fuel stream.

23. The integrated system of claim 1 wherein said fuel processing and conditioning subsystem further comprises a fuel adsorbent system to control said hydrogen-containing fluid fuel stream concentration.

24. The integrated system of claim 23 wherein said fuel adsorbent system comprises at least one of a pressure swing adsorption system and a partial pressure adsorbent system.

25. The integrated system of claim 1 wherein said fuel processing and conditioning system further comprises a semi-permeable membrane for imparting at least one of compositional and mechanical control to said hydrogen-containing fluid fuel stream.

26. The integrated system of claim 25 wherein said membrane controls the concentration of hydrogen in said hydrogen-containing fluid fuel stream.

27. The integrated system of claim 25 wherein said membrane comprises at least one of a polymer membrane and a sintered metal membrane.

28. The integrated system of claim 1 wherein said fuel processing and conditioning subsystem comprises a reformer for producing a hydrogen-containing fluid fuel stream from one of said at least one raw fuel stream.

29. The integrated system of claim 28 wherein said reformer comprises at least one of an autothermal reformer, a steam reformer and a partial oxidation reformer.

30. The integrated system of claim 1 wherein said fuel cell subsystem oxidant processing and conditioning system is integrated with the engine oxidant supply system.

31. The integrated system of claim 30 wherein said fluid oxidant stream of said oxidant processing and conditioning system is drawn from the engine oxidant supply system.

32. The integrated system of claim 1 wherein said oxidant processing and conditioning subsystem further comprises an oxidant adsorbent system to control said oxygen-containing fluid oxidant stream concentration.

33. The integrated system of claim 32 wherein said oxidant adsorbent system comprises at least one of a pressure swing adsorption system and a partial pressure adsorbent system.

34. The integrated system of claim 1 wherein said oxidant processing and conditioning system further comprises a semi-permeable membrane for imparting at least one of compositional and mechanical control to said oxygen-containing fluid oxidant stream.

35. The integrated system of claim 34 wherein said membrane controls the concentration of oxygen in said oxygen-containing fluid oxidant stream.

36. The integrated system of claim 35 wherein said membrane comprises at least one of a polymer membrane and a sintered metal membrane.

37. The integrated system of claim 1 wherein said fuel cell electric power generation subsystem is actuatable to generate electric current when said engine subsystem is not actuated.

38. The integrated system of claim 1 wherein said engine subsystem is actuatable to generate mechanical power when said fuel cell electric power generation subsystem is not actuated.

39. The integrated system of claim 1 wherein said fuel cell electric power generation subsystem is actuatable to generate electric current when said engine subsystem is actuated to generate mechanical power.

40. The integrated system of claim 1 wherein said engine subsystem is actuatable to generate mechanical when said fuel cell electric power generation subsystem is actuated to generate electrical current.

41. The integrated system of claim 1 wherein said power conditioning and buffering subsystem comprises a DC-to-AC power inverter.

42. The integrated system of claim 1 wherein said power conditioning and buffering subsystem comprises a voltage step-up/step-down device.

43. The integrated system of claim 1 wherein said power conditioning and buffering subsystem comprises a current step-up/step-down device.

44. The integrated system of claim 1 wherein said power conditioning and buffering subsystem comprises a frequency modulation device.

45. The integrated system of claim 1 wherein said power conditioning and buffering subsystem comprises a device for storing and releasing electric current upon demand.

46. The integrated system of claim 45 wherein said storing and releasing device comprises at least one capacitor.

47. The integrated system of claim 45 wherein said storing and releasing device comprises at least one battery.

48. The integrated system of claim 1 wherein said power conditioning and buffering subsystem comprises a DC-to-AC power inverter, at least one capacitor and at least one battery.

49. The integrated system of claim 1 wherein at least a portion said hydrogen-containing fluid fuel stream is directed to at least one emission control device.

50. The integrated system of claim 49 wherein said at least a portion of said hydrogen-containing fluid fuel stream is at least periodically directed to said at least one emission control device.

51. The integrated system of claim 50 wherein said at least a portion of said hydrogen-containing fluid fuel stream is periodically directed to said at least one emission control device at predetermined intervals.

52. The integrated system of claim 50 wherein said at least a portion of said hydrogen-containing fluid fuel stream is continuously directed to said at least one emission control device.

53. The integrated system of claim 50 where said at least one emissions control device comprises at least one catalyst.

54. The integrated system of claim 50 where said at least one emissions control device comprises at least one adsorbent.

55. The integrated system of claim 54 where said at least one emissions control device further comprises at least one catalyst.

56. The integrated system of claim 1 wherein said fuel cell comprises a proton exchange membrane (PEM).

57. The integrated system of claim 1 wherein at least a portion of said heat and water from said combustion engine is directed to said fuel processing and conditioning system, thereby increasing system efficiency.

58. The integrated system of claim 1 wherein said fuel cell comprises a device to reject heat generated by said fuel cell.

59. A method of operating an integrated fuel cell and additive gas supply system for a power generation system including a combustion engine, the method comprising:
(a) generating mechanical power, heat and an engine exhaust stream from a combustible fuel stream and a combustible oxidant stream using an actuatable engine subsystem comprising a combustion engine;
(b) introducing a hydrogen-containing fluid stream into said combustible oxidant stream to form a combined stream;
(c) separately introducing said combined stream and said combustible fuel stream into said engine and combusting said combined stream and said combustible fuel stream therein;
(d) generating electric current, heat, and product water from a fuel stream and an oxidant stream using an actuatable fuel cell electric power generation subsystem comprising an electrochemical fuel cell;
(e) providing conditioned electric power to at least one electrical load using a power conditioning and buffering subsystem capable of receiving electric current from said electrochemical fuel cell.

60. The method of claim 59 wherein said fuel cell electric power generation subsystem comprises a plurality of electrochemical fuel cells.

61. The method of claim 59 wherein said combustion engine generates mechanical power to energize a vehicle.

62. The method of claim 59 wherein said combustion engine generates mechanical power to energize a stationary device.

63. The method of claim 59 wherein said fuel cell produces a fuel exhaust stream, and said hydrogen-containing fluid stream is drawn from said fuel cell fuel exhaust stream.

64. The method of claim 59 further comprising imparting water to said hydrogen-containing fluid fuel stream to produce a humidified hydrogen-containing fluid fuel stream.

65. The method of claim 59 further comprising employing a semi-permeable membrane to impart at least one of compositional and mechanical control to said hydrogen-containing fluid fuel stream.

66. The method of claim 65 wherein said membrane controls the concentration of hydrogen in said hydrogen-containing fluid fuel stream.

67. The method of claim 59 wherein said fluid oxidant stream is drawn from the engine oxidant supply system.

68. The method of claim 59 wherein an oxidant adsorbent system controls said oxygen-containing fluid oxidant stream concentration.

69. The method of claim 59 wherein said fuel cell electric power generation subsystem is actuatable to generate electric current when said engine subsystem is not actuated.

70. The method of claim 59 wherein said engine subsystem is actuatable to generate mechanical power when said fuel cell electric power generation subsystem is not actuated.

71. The method of claim 59 wherein said fuel cell electric power generation subsystem is actuatable to generate electric current when said engine subsystem is actuated to generate mechanical power.

72. The method of claim 59 wherein said engine subsystem is actuatable to generate mechanical when said fuel cell electric power generation subsystem is actuated to generate electrical current.

73. The method of claim 59 wherein at least a portion said hydrogen-containing fluid fuel stream is directed to at least one emission control device.

74. The method of claim 73 wherein said at least a portion of said hydrogen-containing fluid fuel stream is at least periodically directed to said at least one emission control device.

75. The method of claim 73 wherein said at least a portion of said hydrogen-containing fluid fuel stream is periodically directed to said at least one emission control device at predetermined intervals.

76. The method of claim 73 wherein said at least a portion of said hydrogen-containing fluid fuel stream is continuously directed to said at least one emission control device.

77. The method of claim 59 wherein said fuel cell comprises a proton exchange membrane (PEM).
